(19) United States
(12) Patent Application Publication
(10) Pub. No.: US 2025/0270015 A1
(43) Pub. Date: Aug. 28, 2025

(54) GAS BARRIER FILM, PACKAGING FILM, PACKAGING BAG, AND PACKAGING PRODUCT

(71) Applicant: TOPPAN HOLDINGS INC., Tokyo (JP)

(72) Inventor: Miki FUKUGAMI, Tokyo (JP)

(73) Assignee: TOPPAN HOLDINGS INC., Tokyo (JP)

(21) Appl. No.: 19/195,498

(22) Filed: Apr. 30, 2025

Related U.S. Application Data
(63) Continuation of application No. PCT/JP2023/038572, filed on Oct. 25, 2023.

(30) Foreign Application Priority Data
Nov. 8, 2022 (JP) 2022-178940

(51) Int. Cl. B65D 65/42; C08J 7/04; C08J 7/043; C08J 7/048; C09D 5/00; C09D 7/61; C09D 7/63; C09D 129/04; C09D 175/14

(52) U.S. Cl. CPC B65D 65/42; C08J 7/042; C08J 7/043; C08J 7/048; C09D 5/002; C09D 7/61; C09D 7/63; C09D 129/04; C09D 175/14; B65D 2565/387; C08J 2323/12; C08J 2429/04; C08J 2475/14

(57) ABSTRACT

A gas barrier film includes a substrate layer including a thermoplastic resin, a deposition layer, and a gas barrier coating layer in this order. The gas barrier coating layer has an atomic number density of 10.5*10²² to 13.0*10²² atoms/cm³ and a density of 1.6 to 2.1 g/cm³.

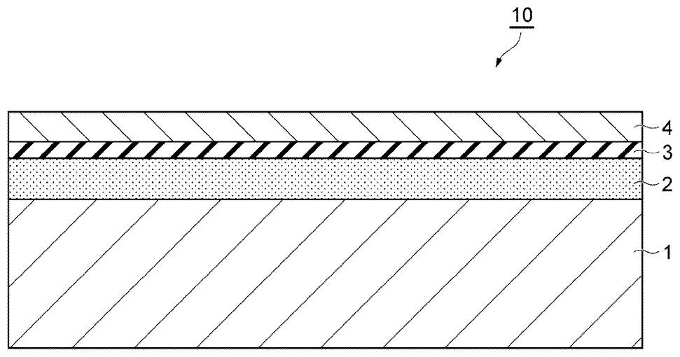

### CROSS-REFERENCE TO RELATED PATENT APPLICATIONS

The present application is a Bypass Continuation of International Patent Application No. PCT/JP2023/038572, filed Oct. 25, 2023, which claims priority to and the benefit of Japanese Patent Application No. 2022-178940, filed on Nov. 8, 2022. The contents of these applications are hereby incorporated by reference herein in their entireties.

### TECHNICAL FIELD

The present invention relates to a gas barrier film, a packaging film, a packaging bag, and a packaging product.

### BACKGROUND

Gas barrier films are widely used for packaging materials for foods and medicines, which are subjected to heat sterilization treatment such as boiling treatment and retort treatment. When contents such as foods and medicines are packed, it is important to reduce an oxygen transmission rate in order to suppress deterioration and decomposition of the contents and maintain quality thereof. Hence, conventionally, as a gas barrier film suited for such uses, one using a polyolefin film substrate having heat resistance and a low oxygen transmission rate is used.

For example, Patent Literature 1 discloses a gas barrier laminate including a substrate layer containing a polyolefin, a metal oxide layer, and a gas barrier cover layer in this order. The gas barrier cover layer contains a water-soluble polymer and at least one of a silicon alkoxide or a hydrolysate thereof, and a content ratio a/b between a content of silicon atoms of the silicon alkoxide or the hydrolysate thereof (mass part a) and a content of the water-soluble polymer (mass part b) is 3/97 or more and 45/55 or less in mass ratio. Hence, it is illustrated that the gas barrier laminate has superior gas barrier properties after retort sterilization treatment or an abuse test.
[Citation List] [Patent Literature] Patent Literature 1: WO 2021/220977 A1

### SUMMARY OF THE INVENTION

### Technical Problem

However, conventional gas barrier films have room for further improvement in oxygen barrier properties and adhesion after heat sterilization treatment.

An aspect of the present invention aims to provide a gas barrier film having low oxygen transmittance and superior adhesion even after heat sterilization treatment (for, example, retort treatment at 130° C. for 60 minutes). Another aspect of the present invention aims to provide a packaging film, a packaging bag, and a packaging product using the gas barrier film.

### Solution to Problem

An aspect of the present invention relates to, for example, the following [1] to [12].

[1] A gas barrier film including a substrate layer including a thermoplastic resin, a deposition layer, and a gas barrier coating layer in this order, wherein
the gas barrier coating layer has an atomic number density of 10.5*10²² to 13.0*10²² atoms/cm³ and a density of 1.6 to 2.1 g/cm³.

[2] The gas barrier film according to [1], wherein
oxygen transmittance is 5.0 cm³/(m²·day·atm) or lower, and lamination strength is 1.5 N/15 mm or greater.

[3] The gas barrier film according to [1] or [2], wherein
the thermoplastic resin is a polypropylene resin.

[4] The gas barrier film according to any one of [1] to [3], wherein
a content of polypropylene in the gas barrier film is 90 mass % or greater.

[5] The gas barrier film according to any one of [1] to [4], further including an anchor coating layer between the substrate layer and a deposition layer.

[6] The gas barrier film according to any one of [1] to [5], wherein
the deposition layer includes at least one selected from a group including aluminum oxide and silicon oxide.

[7] The gas barrier film according to any one of [1] to [6], wherein
the gas barrier coating layer is formed of a cured body of a composition including a water-soluble polymer having a hydroxyl group, a metal alkoxide or hydrolysate thereof, and a silane coupling agent or hydrolysate thereof.

[8] The gas barrier film according to any one of [1] to [7], wherein
a content of silicon oxide in the gas barrier coating layer is 30 to 80 mass %.

[9] The gas barrier film according to any one of [1] to [8], wherein
a thickness of the gas barrier coating layer is 80 to 1000 nm.

[10] A packaging film including the gas barrier film according to any one of [1] to [9] and a sealant layer.

[11] A packaging bag including the packaging film according to [10].

[12] A packaging product including the packaging bag according to and contents accommodated in the packaging bag.

### Advantageous Effects of the Invention

According to the present invention, a gas barrier film can be provided which has low oxygen transmittance and superior adhesion even after heat sterilization treatment (for example, retort treatment at 130° C. for 60 minutes). In addition, according to the present invention, a packaging film, a packaging bag, and a packaging product using the gas barrier film can be provided.

### BRIEF DESCRIPTION OF THE DRAWINGS

The FIGURE is a schematic sectional view illustrating a gas barrier film according to an embodiment of the present invention.

### DETAILED DESCRIPTION

### Description of the Embodiments

Hereinafter, an embodiment of the present invention will be described in detail with reference to the drawings depending on the situation. However, the present invention is not limited to the following embodiment.

### <Gas Barrier Film>

The FIGURE is a schematic sectional view illustrating a gas barrier film according to an embodiment of the present invention. As illustrated in the FIGURE, a gas barrier film 10 includes a substrate layer 1, an anchor coating layer 2, a deposition layer 3, and a gas barrier coating layer 4 in this order.

The gas barrier film according to the embodiment has low oxygen transmittance and superior adhesion even after heat sterilization treatment. The oxygen transmittance after performing heat sterilization treatment on the gas barrier film may be, for example, 5.0 cm³/(m²·day·atm) or lower, 4.0 cm³/(m²·day·atm) or lower, or 3.5 cm³/(m²·day·atm) or lower. Lamination strength of the gas barrier film after the heat sterilization treatment may be 1.5 N/15 mm or greater, 2.0 N/15 mm or greater, 2.5 N/15 mm or greater, 3.0 N/15 mm or greater, or 3.5 N/15 mm or greater. Herein, the heat sterilization treatment means the treatment described in the examples described later, and the oxygen transmittance and the lamination strength mean numerical values measured by the methods described in the examples described later.

The content of polypropylene in the gas barrier film may be 90 mass % or greater, 95 mass % or greater, or 98 mass % or greater from the viewpoint of achieving a monomaterial and improving recyclability.

### [Substrate Layer]

The substrate layer is a film (base film) serving as a support and includes a thermoplastic resin. Examples of the thermoplastic resin include polyethylene, polypropylene, polystyrene, polyvinyl chloride, polyethylene terephthalate (PET), and the like. The thermoplastic resin may be polypropylene from the viewpoint of achieving a monomaterial and improving recyclability. If the thermoplastic resin is PET, compared with a case in which the thermoplastic resin is polypropylene, lower oxygen transmittance and further superior adhesion are easily achieved even after heat sterilization treatment.

The polypropylene may be homopolypropylene or a propylene copolymer. Examples of the propylene copolymer include polypropylene-based copolymers such as a propylene-ethylene random copolymer, a propylene-ethylene block copolymer, and a propylene-α-olefin copolymer.

The polypropylene may be recycled polypropylene or polypropylene obtained by polymerization of biomass-derived raw materials such as plants. These polypropylenes may be used independently. These polypropylenes may be used with being mixed with polypropylene obtained by polymerization from fossil fuel.

The substrate layer may be an oriented film or a non-oriented film. From the viewpoint of lowering oxygen transmittance, the substrate layer may be an oriented film. If the substrate layer is an oriented film, the oriented film may include a uniaxially-oriented film and a biaxially-oriented film. From the viewpoint of improving heat resistance, the oriented film may be a biaxially-oriented film.

The substrate layer may contain known additives. The additive may be, for example, an organic additive such an antioxidant, a stabilizer, a lubricant such as calcium stearate, fatty acid amide, erucamide, or the like, or an antistatic agent; or an inorganic additive such as silica, zeolite, thyroid, hydrotalcite, or particulate lubricant such as silicon particles.

The content of polypropylene in the substrate layer may be 90 mass % or greater, 95 mass % or greater, or 98 mass % or greater from the viewpoint of achieving a monomaterial and improving recyclability. The content of polypropylene in the substrate layer may be substantially 100 mass % (an aspect in which the substrate layer is formed of polypropylene).

The thickness of the substrate layer may be, for example, 3 μm or larger, 6 μm or larger, or 10 μm or larger, or 200 μm or smaller, 100 μm or smaller, 50 μm or smaller, 30 μm or smaller, or 20 μm or smaller.

### [Anchor Coating Layer]

The gas barrier film may further include or may not include an anchor coating layer between the substrate layer and the deposition layer. Since the gas barrier film includes the anchor coating layer, low oxygen transmittance and superior adhesion are easily achieved even after heat sterilization treatment.

The anchor coating layer can be formed by, for example, applying a composition for forming an anchor coating layer (anchor coating agent) on the substrate layer and thereafter drying it. Examples of the anchor coating agent include a solution including an acrylic resin, an epoxy resin, an acrylic urethane-based resin, a polyester-based polyurethane resin, a polyether-based polyurethane resin, and the like. From the viewpoint of superior heat resistance and interlaminar adhesion, the anchor coating agent may include at least one selected from a group including acrylic urethane resins and polyester-based polyurethane resins.

From the viewpoint of being able to further improve adhesion between the substrate layer and the deposition layer, the thickness of the anchor coating layer may be 0.05 μm or larger, 0.08 μm or larger, or 0.1 μm or larger. From the viewpoint of easily imparting flexibility to the anchor coating layer and easily maintaining low oxygen transmittance even if external factors such as folding and stretching are applied after the layer is formed, the thickness of the anchor coating layer may be 2 μm or smaller, 1.5 μm or smaller, or 1 μm or smaller.

### [Deposition Layer]

The deposition layer is a layer provided on the substrate layer from the viewpoint of lowering oxygen transmittance. The deposition layer preferably has transparency.

The deposition layer may include an inorganic oxide. Examples of the inorganic oxide include aluminum oxide, silicon oxide, tin oxide, magnesium oxide, mixtures of these, and the like. From the viewpoint of further superior heat resistance during heat sterilization treatment, the deposition layer may include at least one selected from a group including aluminum oxide and silicon oxide.

From the viewpoint of superior productivity, the deposition layer may be formed by a vacuum evaporation method. The deposition layer may be formed by a thin film formation method other than the vacuum evaporation method, that is, a sputtering method, an ion plating method, a plasma vapor phase growth method (CVD), or the like.

As a heating means of the vacuum evaporation method, any of an electron beam heating method, a resistance heating method, and an induction heating method may be used. The heating means of the vacuum evaporation method may be the electron beam heating method because of wide selectivity of evaporation materials.

From the viewpoint of improving adhesion with the substrate layer and compactness of the deposition layer, the deposition layer may be formed by a plasma assisted method or an ion beam assisted method. From the viewpoint of improving transparency of the deposition layer, the deposition layer may be formed by reactive evaporation that supplies a variety of gases such as oxygen when vapor deposition is performed.

From the viewpoint of easily uniforming the thickness of the deposition layer and more easily ensuring functions as a gas barrier film, the thickness of the deposition layer may be 5 nm or larger, 15 nm or larger, or 20 nm or larger. From the viewpoint of easily imparting flexibility to the deposition layer and resistance to cracking in the deposition layer even if external factors such as folding and stretching are applied after the layer is formed, the thickness of the deposition layer may be 300 nm or smaller, 150 nm or smaller, or 100 nm or smaller.

### [Gas Barrier Coating Layer]

The gas barrier coating layer is provided in order to protect the deposition layer and lower oxygen transmittance of the gas barrier film. The gas barrier coating layer may be formed of a cured body of a composition including water-soluble polymers having hydroxyl groups, metal alkoxide or a hydrolysate thereof, and a silane coupling agent or a hydrolysate thereof. The gas barrier coating layer may be formed of a cured body of a composition including water-soluble polymers having hydroxyl groups, and metal alkoxide or a hydrolysate thereof. From the viewpoint of easily achieving lower oxygen transmittance and further superior adhesion even after heat sterilization treatment, the gas barrier coating layer may be formed of a cured body of a composition including water-soluble polymers having hydroxyl groups, metal alkoxide or a hydrolysate thereof, and a silane coupling agent or a hydrolysate thereof. When the composition forming the gas barrier coating layer includes no silane coupling agent, making the content of the water-soluble polymers having hydroxyl groups in the composition lower than the content of metal alkoxide easily achieves low oxygen transmittance and superior adhesion even after heat sterilization treatment.

Examples of water-soluble polymers having hydroxyl groups include polyvinyl alcohol, polyvinylpyrrolidone, starch, methylcellulose, carboxymethylcellulose, sodium alginate, and the like. From the viewpoint of further lowering oxygen transmittance even after heat sterilization treatment, the water-soluble polymers having hydroxyl groups may be polyvinyl alcohol (PVA).

The metal alkoxide includes a compound expressed by the following general expression (1).

M(OR¹¹)ₘ(R¹²)ₙ₋ₘ (1)

In the above expression (1), R¹¹ is a monovalent organic group having a carbon number of 1 to 8 and may be an alkyl group such as a methyl group and an ethyl group (OR¹¹ is a hydrolyzable group). R¹² is a monovalent organic group having a carbon number of 1 to 8 and may be an alkyl group such as a methyl group and an ethyl group. M indicates an n-valent metal atom such as Si, Ti, Al, or Zr. m indicates an integer 1 to n. It is noted that when plural R¹¹ and R¹² are present, each of R¹¹ or each of R¹² may be the same or may be different from each other.

Specific examples of the metal alkoxide include tetraethoxysilane [Si(OC₂H₅)₄], triisopropoxy aluminum [Al(O-2′-C₃H₇)₃], and the like. Tetraethoxysilane (TEOS) and triisopropoxy aluminum are preferable because they are relatively stable in an aqueous solvent after hydrolysis. From the viewpoint of easily achieving lower oxygen transmittance and further superior adhesion even after heat sterilization treatment, the metal alkoxide may be tetraethoxysilane.

Examples of the silane coupling agent include a compound expressed by the following general expression (2).

Si(OR²¹)ₚ(R²²)₃₋ₚ(R²³) (2)

In the above expression (2), R²¹ indicates an alkyl group such as a methyl group and an ethyl group, R²² indicates a monovalent organic group such as an alkyl group, an aralkyl group, an aryl group, an alkenyl group, an alkyl group for which an acryloxy group is substituted, and an alkyl group for which a methacryloxy group is substituted. R²³ indicates a monovalent organic functional group, and p indicates an integer 1 to 3. It is noted that when plural R²¹ or R²² are present, each of the R²¹ and each of the R²² may be the same or may be different from each other. Examples of the monovalent organic functional group indicated by R²³ include a monovalent organic functional group containing a glycidyloxy group, an epoxy group, a mercapto group, a hydroxyl group, an amino group, an alkyl group for which a halogen atom is substituted, or an isocyanate group. A compound obtained by providing these silane coupling agents as a multimer such as a dimer or a trimer may be used.

Specific examples of the silane coupling agent include silane coupling agents such as Vinyltrimethoxysilane, γ-Chloropropylmethyldimethoxysilane, γ-Chloropropyltrimethoxysilane, 3-Glycidoxypropylmethyldimethoxysilane, 3-Glycidoxypropyltrimethoxysilane, 3-Glycidoxypropylmethyldiethoxysilane. 3-Glycidoxypropylmethyltriethoxysilane, γ-Methacryloxypropyltrimethoxysilane, γ-Methacryloxypropylmethyldimethoxysilane, and 1,3,5-Tris(3-methoxysilylpropyl) isocyanurate, and the like. From the viewpoint of easily achieving lower oxygen transmittance and further superior adhesion even after heat sterilization treatment, the silane coupling agent may be 1,3,5-Tris(3-methoxysilylpropyl) isocyanurate.

The gas barrier coating layer contains, for example, hydrogen atoms, carbon atoms, oxygen atoms, and metal atoms. The hydrogen atoms and carbon atoms are principally derived from a water-soluble polymer having hydroxyl groups, metal alkoxide, a silane coupling agent, and the like. The oxygen atoms are principally derived from metal alkoxide and a silane coupling agent. The metal atoms are principally derived from metal alkoxide and a silane coupling agent. The metal atoms may be silicon atoms. The ratio of nitrogen atoms in the gas barrier coating layer may be 2.0 atomic % or less.

It can be confirmed that the gas barrier coating layer contains atoms such as hydrogen atoms, carbon atoms, oxygen atoms, and metal atoms by performing a surface analysis of the gas barrier coating layer by Rutherford backscattering spectrometry (RBS) and Hydrogen forward scattering spectrometry (HFS). In addition, the number of these atoms can be measured by Rutherford backscattering spectrometry and Hydrogen forward scattering spectrometry, specifically, by the method described in the example described later.

The atomic number density of the gas barrier coating layer is 10.5*10²² to 13.0*10²² atoms/cm³. Since the atomic number density of the gas barrier coating layer is 10.5*10²² atoms/cm³ or higher, the gas barrier coating layer is suppressed from being too hard and becomes resistant to breakage, and the oxygen transmittance tends to remain lower even after heat sterilization treatment. Since the atomic number density of the gas barrier coating layer is 13.0*10²² atoms/cm³ or lower, heat resistance is superior, and the oxygen transmittance is lowered even after heat sterilization treatment, whereby superior adhesion can be easily achieved. The atomic number density of the gas barrier coating layer can be calculated by the method described in the example described later.

From the viewpoint of further suppressing the gas barrier coating layer from being too hard and becoming further resistant to break the gas barrier coating layer, and more easily maintaining lower oxygen transmittance even after heat sterilization treatment, the atomic number density may be 10.55*10²² atoms/cm³ or higher or 10.6*10²² atoms/cm³ or higher. From the viewpoint of superior heat resistance and further lowering oxygen transmittance even after heat sterilization treatment, which easily achieves further superior adhesion, the atomic number density may be 12.5*10²² atoms/cm³ or lower, 12.0*10²² atoms/cm³ or lower, or 11.7*10²² atoms/cm³ or lower.

The atomic number density of the gas barrier coating layer can be adjusted, for example, by adjusting the type and the amount of components (water-soluble polymers having hydroxyl groups, metal alkoxide, a silane coupling agent, or the like) contained by the gas barrier coating layer, and a drying temperature of the gas barrier coating layer.

More specifically, when the content of water-soluble polymers having hydroxyl groups is increased with respect to the content of metal alkoxide, the atomic number density of the gas barrier coating layer tends to increase. In addition, when the content of water-soluble polymers having hydroxyl groups is increased with respect to the content of the silane coupling agent, the atomic number density of the gas barrier coating layer tends to increase. In addition, when the content of the silane coupling agent is increased with respect to the content of metal alkoxide, the atomic number density of the gas barrier coating layer tends to increase. In addition, when the drying temperature of the gas barrier coating layer is lowered, the atomic number density of the gas barrier coating layer tends to increase.

The density of the gas barrier coating layer is 1.6 to 2.1 g/cm³. Since the density of the gas barrier coating layer is 1.6 g/cm³ or higher, heat resistance is superior, and the oxygen transmittance remains low even after heat sterilization treatment, whereby superior adhesion can be easily achieved. Since the density of the gas barrier coating layer is 2.1 g/cm³ or lower, the gas barrier coating layer is suppressed from being too hard and becomes resistant to breakage, and the oxygen transmittance tends to remain low even after heat sterilization treatment. The density of the gas barrier coating layer can be calculated by the method described in the example described later. Although the densities of conventional gas barrier coating layers are 1.6 g/cm³ or lower, the density of the gas barrier coating layer of the gas barrier film according to the embodiment is 1.6 to 2.1 g/cm³. Hence, a gas barrier film can be achieved which has low oxygen transmittance and superior adhesion even after heat sterilization treatment.

From the viewpoint of further superior heat resistance and further lowering oxygen transmittance even after heat sterilization treatment, which easily achieves further superior adhesion, the density may be 1.65 g/cm³ or higher, or 1.7 g/cm³ or higher. From the viewpoint of suppressing the gas barrier coating layer from being too hard and becoming further resistant to break the gas barrier coating layer, and more easily maintaining lower oxygen transmittance even after heat sterilization treatment, the density may be 2.05 g/cm³ or lower or 2.0 g/cm³ or lower.

The density of the gas barrier coating layer can be adjusted, for example, by adjusting the type and the amount of components (water-soluble polymers having hydroxyl groups, metal alkoxide, a silane coupling agent, or the like) contained in the gas barrier coating layer, and a drying temperature of the gas barrier coating layer.

More specifically, when the content of water-soluble polymers having hydroxyl groups is increased with respect to the content of metal alkoxide, the density of the gas barrier coating layer tends to increase. In addition, when the content of water-soluble polymers having hydroxyl groups is increased with respect to the content of the silane coupling agent, the density of the gas barrier coating layer tends to decrease. In addition, when the content of metal alkoxide is increased with respect to the content of the silane coupling agent, the atomic number density of the gas barrier coating layer tends to increase. In addition, when the drying temperature of the gas barrier coating layer is lowered, the density of the gas barrier coating layer tends to decrease.

The gas barrier coating layer can be formed by coating the deposition layer with a composition for forming a gas barrier coating layer, and thereafter drying it by heating. The composition for forming a gas barrier coating layer can be prepared by mixing one obtained by dissolving water-soluble polymers in an aqueous solvent (water, a mixed solvent of water and alcohol, or the like) with at least any one of metal alkoxide and a silane coupling agent or one obtained by previously subjecting these to hydrolysis. To this composition (mixed solution), an isocyanate compound; a known additive such as a dispersant, a stabilizer, a viscosity modifier, a colorant, and the like may be added.

When PVA is included as a water-soluble polymer having hydroxyl groups, from the viewpoint of maintaining flexibility of the gas barrier coating layer and easily forming the gas barrier coating layer, the amount of PVA in the composition may be 15 mass % or greater, 20 mass % or greater, or 25 mass % or greater with reference to the total solid content of the composition. When PVA is included as a water-soluble polymer having hydroxyl groups, from the viewpoint of easily maintaining low oxygen transmittance even after heat sterilization treatment, the amount of PVA in the composition may be 70 mass % or less, 60 mass % or less, or 50 mass % or less with reference to the total solid content of the composition.

When TEOS (Tetraethoxysilane) is included as metal alkoxide, from the viewpoint of easily maintaining low oxygen transmittance even after heat sterilization treatment, the amount of TEOS in the composition may be 30 mass % or greater, 35 mass % or greater, or 40 mass % or greater with reference to the total solid content of the composition. When TEOS is included as metal alkoxide, from the viewpoint of maintaining flexibility of the gas barrier coating layer and easily forming the gas barrier coating layer, the amount of TEOS in the composition may be 80 mass % or less, 75 mass % or less, or 70 mass % or less with reference to the total solid content of the composition. It is noted that, herein, the amount of TEOS means a value converted to SiO₂.

When isocyanurate silane is included as the silane coupling agent, from the viewpoint of easily achieving hot water resistance and easily achieving superior adhesion even after heat sterilization treatment, the amount of the isocyanurate silane in the composition may be 1 mass % or greater, 3 mass % or greater, or 5 mass % or greater with reference to the total solid content of the composition. When isocyanurate silane is included as the silane coupling agent, from the viewpoint of not excessively decreasing the amount of other components in the composition and easily maintaining low oxygen transmittance even after heat sterilization treatment, the amount of the isocyanurate silane in the composition may be 20 mass % or less, 15 mass % or less, or 10 mass % or less with reference to the total solid content of the composition.

From the viewpoint of easily achieving further superior adhesion even after heat sterilization treatment, the ratio of the content of metal alkoxide to the content of water-soluble polymers having hydroxyl groups in the composition (content of metal alkoxide/content of water-soluble polymers having hydroxyl groups) may be 0.5 or higher, 0.6 or higher, 0.7 or higher, or 0.8 or higher. From the viewpoint of easily achieving lower oxygen transmittance even after heat sterilization treatment, the ratio may be 5 or lower, 4 or lower, 3 or lower, 2.5 or lower, 2 or lower, or 1 or lower.

From the viewpoint of easily achieving lower oxygen transmittance and further superior adhesion even after heat sterilization treatment, the ratio of the content of the silane coupling agent to the content of water-soluble polymers having hydroxyl groups in the composition (content of the silane coupling agent/content of water-soluble polymers having hydroxyl groups) may be 0 or higher, 0.1 or higher, 0.2 or higher, or 0.22 or higher. From the viewpoint of easily achieving lower oxygen transmittance even after heat sterilization treatment, the ratio may be 0.45 or lower, 0.4 or lower, or 0.35 or lower.

From the viewpoint of easily achieving lower oxygen transmittance and further superior adhesion even after heat sterilization treatment, the ratio of the content of the silane coupling agent to the content of metal alkoxide in the composition (content of the silane coupling agent/content of metal alkoxide) may be 0 or higher, 0.1 or higher, 0.2 or higher, or 0.22 or higher. From the viewpoint of easily achieving further superior adhesion even after heat sterilization treatment, the ratio may be 2 or lower, 1 or lower, 0.8 or lower, 0.6 or lower, or 0.4 or lower.

From the viewpoint of further superior heat resistance and further lowering oxygen transmittance even after heat sterilization treatment, which easily achieves superior adhesion, the content of silicon oxide in the gas barrier coating layer may be 30 mass % or greater, 35 mass % or greater, or 40 mass % or greater. From the viewpoint of suppressing the gas barrier coating layer from being too hard and becoming further resistant to break the gas barrier coating layer, and more easily maintaining lower oxygen transmittance even after heat sterilization treatment, the content of silicon oxide in the gas barrier coating layer may be 80 mass % or less, 75 mass % or less, or 70 mass % or less.

From the viewpoint of easily achieving lower oxygen transmittance and further superior adhesion even after heat sterilization treatment, the drying temperature at which the gas barrier coating layer is formed may be 40° C. or higher, 50° C. or higher, 60° C. or higher, or 90° C. or higher. From the viewpoint of easily achieving lower oxygen transmittance and further superior adhesion even after heat sterilization treatment, the drying temperature may be 140° C. or lower, 130° C. or lower, or 120° C. or lower.

The thickness of the gas barrier coating layer may be 80 nm or larger, 90 nm or larger, or 100 nm or larger. If the thickness of the gas barrier coating layer is 80 nm or larger, low oxygen transmittance is easily maintained even after heat sterilization treatment. The thickness of the gas barrier coating layer may be 1000 nm or smaller, 700 nm or smaller, 500 nm or smaller, or 400 nm or smaller. If the thickness of the gas barrier coating layer is 1000 nm or smaller, gas barrier properties can be suppressed from lowering due to occurrence of cracking in the layer during coating. From the above viewpoint, the thickness of the gas barrier coating layer may be 80 to 1000 nm.

### <Packaging Film>

Another embodiment of the present invention is a packaging film including the above gas barrier film and a sealant layer. The sealant layer may be provided to the gas barrier coating layer side of the gas barrier film via an adhesion layer.

### (Adhesion Layer)

The adhesion layer bonds the films to each other. Examples of adhesive agents configuring the adhesion layer include a polyurethane resin obtained by applying a bifunctional or higher isocyanate compound to a main agent such as a polyester polyol, a polyether polyol, an acrylic polyol, or a carbonate polyol. One of the variety of polyols may be used independently, or two or more of the variety of polyols may be used in combination. From the viewpoint of heat resistance during heat sterilization treatment, the adhesion layer may be configured by a two-component curable urethane-based adhesive agent.

In order to improve adhesiveness, into the polyurethane resin described above, a carbodiimide compound, an oxazoline compound, an epoxy compound, a phosphorus compound, a silane coupling agent, or the like may be compounded. As the adhesive agent, from the viewpoint of environmental compatibility, one having biomass-derived macromolecular components or one having biodegradability may be used. The adhesive agent may have gas barrier properties.

From the viewpoint of obtaining desired adhesive strength, followability, workability, and the like, the application quantity of the adhesive agent may be, for example, 0.5 to 10 g/m²·

### (Sealant Layer)

The sealant layer includes a thermoplastic resin, for example, includes a polyolefin-based resin. Examples of the polyolefin-based resin include ethylene-based resins such as a low-density polyethylene resin (LDPE), a medium-density polyethylene resin (MDPE), a linear low-density polyethylene resin (LLDPE), an ethylene-vinyl acetate copolymer (EVA), an ethylene-α-olefin copolymer, an ethylene-(meth)acrylic acid copolymer, and the like, and polypropylene-based resins such as a homopolypropylene resin (PP), a propylene-ethylene random copolymer, a propylene-ethylene block copolymer, a propylene-α-olefin copolymer, and the like, mixtures of these, and the like. Materials of the sealant layer can be appropriately selected from among the thermoplastic resins described above based on uses and temperature conditions of boiling treatment, retort treatment, and the like.

The thermoplastic resin configuring the sealant layer may be stretched or may not be stretched. From the viewpoint of lowering the melting point to make heat sealing easy, the sealant layer may not be stretched.

The thickness of the sealant layer is not specifically limited, but may be, for example, 15 μm or larger, 30 μm or larger, or 50 μm or larger, or may be 200 μm or smaller, 150 μm or smaller, or 100 μm or smaller.

### <Packaging Bag, Packaging Product>

A packaging bag is formed by producing a bag using the packaging film described above. That is, another embodiment of the present invention is a packaging bag including the packaging film. The packaging bag can accommodate contents such as foods and medicines. That is, another embodiment of the present invention is a packaging product including the packaging bag and the contents accommodated in the packaging bag.

The packaging bag may be a bag-shaped one formed by doubling one packaging film so that the sealant layer faces itself and thereafter subjecting the three sides thereof to heat sealing, or may be a bag-shaped one formed by superposing two packaging materials on each other so that the sealant layers face each other and thereafter subjecting the four sides thereof to heat sealing. In addition, the packaging bag may have a shape having a bent part (folded part) such as a standing pouch. The packaging bag according to the present embodiment can maintain superior gas barrier properties even though the packaging bag has a shape having a bent part.

### EXAMPLES

Hereinafter, the present invention will be described by examples in further detail. However, the present invention is not limited to the examples.

### <Preparation of Gas Barrier Film>

### Example 1

A polypropylene film (produced by Mitsui Chemicals Tohcello, Inc., product name: ME-1) having a thickness of 20 μm was coated with the anchor coating agent set forth below by gravure coating and dried, whereby an anchor coating layer having a thickness of 0.1 μm was formed. Next, a deposition layer formed of silicon oxide having a thickness of 25 nm was formed on the anchor coating layer by using a vacuum evaporation device using an electron beam heating method.

### (Anchor Coating Agent)

After acrylic polyols and tolylene diisocyanate were mixed so that the number of NCO groups of the tolylene diisocyanate was equal to the number of OH groups of the acrylic polyester polyols, the mixture was diluted with ethyl acetate so that the total solid content (total amount of acrylic polyols and tolylene diisocyanate) became 5 mass %. To the liquid mixture after the dilution, β-(3,4-epoxycyclohexyl) trimethoxysilane of 5 mass part was added with respect to the total amount of acrylic polyols and tolylene diisocyanate of 100 mass part, and these were mixed to prepare an anchor coating agent.

The deposition layer was coated with the coating liquid set forth below and was dried at 80° C. for one minute, whereby a gas barrier coating layer having a thickness of 320 nm was formed. Hence, a laminate (gas barrier film) was obtained in which a substrate layer/an anchor coating layer/a deposition layer/a gas barrier coating layer were laminated in this order. The content of polypropylene resin in the obtained gas barrier film was 90 mass % or greater.

### (Coating Liquid)

The following liquid A, liquid B, and liquid C were mixed so that the mass ratio between polyvinyl alcohol (PVA) of the liquid A, SiO₂ of the liquid B, and a silane coupling agent (SC agent) of the liquid C became 45:45:10 to prepare a coating agent.

liquid A: An aqueous solution adjusted so that PVA (produced by Kuraray Co., Ltd., product name: Kuraray poval 60-98) becomes 5 mass %.

liquid: B hydrolyzed solution in which tetraethoxysilane (produced by Shin-Etsu Chemical Co., Ltd., product name: KBE04), methanol (produced by KANTO CHEMICAL CO., INC.), and 0.1N hydrochloric acid (produced by KANTO CHEMICAL CO., INC.) were mixed so that the mass ratio became 17:10:73, and which was adjusted so that the solid content became 5 mass % (converted to SiO₂).

liquid C: A hydrolyzed solution in which 1,3,5-Tris(3-methoxysilylpropyl) Isocyanurate was adjusted so that the solid content became 5 mass % (converted to R²Si(OH)₃) in a solution in which the mass ratio between water and IPA (isopropyl alcohol) was 1:1.

### Examples 2 to 8, Comparative Examples 1 to 5

Gas barrier films were obtained as in the example 1 except that the mixture ratio between the A liquid, the B liquid, and the C liquid, the film thickness of the gas barrier coating layer, the drying temperature, and the drying time were changed as illustrated in table 1. Contents of polypropylene resins in the obtained gas barrier films were 90 mass % or greater.

### Example 9

Gas barrier films were obtained as in the example 1 except that a PET film (produced by Futamura Chemical Co., Ltd., product name: FE 2001) having a thickness of 12 μm was used as a substrate, and the drying temperature and the drying time were changed as illustrated in table 1. Contents of polypropylene resins in the obtained gas barrier films were 90 mass % or greater.

### <Preparation of Packaging Film>

An unoriented polypropylene film (produced by Toray Industries, Inc., product name: TORAYFAN ZK207) having a thickness of 60 μm was laminated on the gas barrier coating layer side of the prepared gas barrier film by a dry laminating method via a two-component curable urethane-based adhesive agent (produced by Mitsui Chemicals & SKC Polyurethanes Inc., product name: A525/A52). Thus, a packaging film was obtained.

### <Surface Analysis of Gas Barrier Coating Layer>

Composition of atoms (atomic %) of a surface of the gas barrier coating layer was measured by Rutherford backscattering spectrometry (RBS) and Hydrogen forward scattering spectrometry (HFS). The measurement was performed under the following measurement conditions using a Pelletron 3SDH (National Electrostatics Corp.). A fitting analysis was performed for the spectrum obtained by the measurement based on the composition (atomic %) obtained by the measurement to calculate an area density (atoms/cm²). Next, the thickness of the gas barrier coating layer was measured by using a scanning electron microscope (SEM), and an atomic number density of the gas barrier coating layer was calculated according to the following expression (1).

In addition, densities of respective atoms in the gas barrier coating layer were calculated according to the following expression (2) based on the compositions and the area densities of the respective atoms of the surface of the gas barrier coating layer, and the densities of the respective atoms are summed, whereby the density of the gas barrier coating layer was calculated. The calculation results of the atomic number density and the density of the gas barrier coating layer are illustrated in table 1. In addition, the ratio of nitrogen atoms in the gas barrier coating layer was 2.0 atomic % or less.

$$Atomic number density = area density / thickness \qquad ( 1 )$$

$$Density of each atom = area density * composition of atom * atomic weight of each atom / Avogadro constant / thickness \qquad ( 2 )$$

Density of each atom: g/cm³, area density: atoms/cm², composition of atom: atomic %, thickness: cm.

### (Measurement Conditions)

Incident ion: 4He++
Incident energy: 2300 keV
Incidence angle: 0 deg (RBS independently), 75 deg (RBS/HFS simultaneously)
Scattering angle: 160 deg
Recoil angle: None (RBS independently), 30 deg (RBS/HFS simultaneously)
Sample current: 3 nA
Beam diameter: 2 mmφ
In-plane rotation: None
Irradiation amount: 20 μC (0.1 μC*200 points, RBS independently), 5 μC (0.1 μC*50 points, RBS/HFS simultaneously)

### <Evaluation>

### (Retort Treatment)

The prepared packaging film was cut to a size of 315 mm long and 230 mm wide, and the longitudinal direction thereof was doubled. The three sides thereof were subjected to heat sealing, whereby a pouch having an opening was prepared. Water was poured into this pouch, and the opening was subjected to heat sealing, whereby a sealed pouch was obtained. The prepared sealed pouch was subjected to retort treatment (heat sterilization treatment) at 130° C. for 60 minutes using a hot water storage type retort boiler.

### (Oxygen Transmittance Measurement)

Oxygen transmittance measurement was performed for the sealed pouch after retort treatment. The measurement was performed under conditions of temperature of 30° C. and relative humidity of 70% using an oxygen transmittance measurement device (produced by Modern Control, OXTRAN 2/20). The measurement method conformed to JIS K-7126, B method (isopiestic method) and ASTM D3985-81. Measurement values are expressed in units of [cm³/m²·day·atm]. The results are illustrated in table 1.

### (Lamination Strength Measurement)

The water was removed from the sealed pouch after retort treatment, and lamination strength between the gas barrier film and the unoriented polypropylene film was measured. The measurement conformed to JIS K6854 and was performed with a test width of 15 mm, a peeling speed of 300 mm/min, and a peeling angle of T type. Measurement values are expressed in units of [N/15 mm]. The results are illustrated in table 1.

TABLE 1

| | | | | | | | | | Atomic | | | |
|---|---|---|---|---|---|---|---|---|---|---|---|---|
| | | | Mass ratio of solid | | | | | | number | | Oxygen | |
| | Substrate | | content (mass %) | | | Film | Drying | Drying | density | | transmittance | Laminate |
| | | Thickness | | | SC | thickness | temperature | time | (×10²² | Density | (cm³/m² · | strength |
| | Type | (μm) | PVA | SiO₂ | agent | (nm) | (° C.) | (min) | atoms/cm³) | (g/cm³) | day · atm) | (N/15 mm) |
| Ex. 1 | Polypropylene | 20 | 45 | 45 | 10 | 320 | 80 | 1 | 11.50 | 1.80 | 0.8 | 3.8 |
| Ex. 2 | Polypropylene | 20 | 25 | 70 | 5 | 320 | 80 | 1 | 10.70 | 2.10 | 2.0 | 4.1 |
| Ex. 3 | Polypropylene | 20 | 45 | 45 | 10 | 320 | 110 | 1 | 10.60 | 2.00 | 0.5 | 4.0 |
| Ex. 4 | Polypropylene | 20 | 50 | 40 | 10 | 320 | 80 | 1 | 11.70 | 1.70 | 1.1 | 2.6 |
| Ex. 5 | Polypropylene | 20 | 45 | 45 | 10 | 90 | 80 | 1 | 11.50 | 1.80 | 3.3 | 4.0 |
| Ex. 6 | Polypropylene | 20 | 40 | 60 | 0 | 320 | 80 | 1 | 10.50 | 1.70 | 4.7 | 1.5 |
| Ex. 7 | Polypropylene | 20 | 45 | 45 | 10 | 320 | 80 | 5 | 11.20 | 1.80 | 0.8 | 3.9 |
| Ex. 8 | Polypropylene | 20 | 45 | 40 | 15 | 320 | 80 | 1 | 11.60 | 1.90 | 0.9 | 3.5 |
| Ex. 9 | PET | 12 | 45 | 45 | 10 | 320 | 120 | 5 | 10.20 | 2.20 | 0.4 | 5.2 |
| Comp. | Polypropylene | 20 | 86 | 4 | 10 | 320 | 80 | 1 | 13.40 | 1.40 | 1.2 | 0.7 |
| Ex. 1 | | | | | | | | | | | | |
| Comp. | Polypropylene | 20 | 20 | 70 | 10 | 320 | 80 | 1 | 10.50 | 2.20 | 6.1 | 4.0 |
| Ex. 2 | | | | | | | | | | | | |
| Comp. | Polypropylene | 20 | 55 | 45 | 0 | 320 | 80 | 1 | 10.60 | 1.50 | 8.5 | 0.2 |
| Ex. 3 | | | | | | | | | | | | |
| Comp. | Polypropylene | 20 | 45 | 45 | 10 | 320 | 120 | 5 | 10.20 | 2.20 | 5.8 | 4.2 |
| Ex. 4 | | | | | | | | | | | | |
| Comp. | Polypropylene | 20 | 45 | 45 | 10 | 320 | 40 | 5 | 14.20 | 1.50 | 12.6 | 0.8 |
| Ex. 5 | | | | | | | | | | | | |

From the comparison between example 1 and example 3, it is found that decreasing the drying temperature tends to increase the atomic number density and decrease the density. In addition, from the comparison between example 1 and example 3, it is found that increasing the drying temperature can achieve lower oxygen transmittance and further superior adhesion even after heat sterilization treatment.

From the comparison between example 1 and example 4, it is found that increasing the amount of water-soluble polymers having hydroxyl groups while making the amount of the silane coupling agent constant tends to increase the atomic number density and decrease the density. In addition, from the comparison between example 1 and example 4, it is found that decreasing the amount of water-soluble polymers having hydroxyl groups while making the amount of the silane coupling agent constant can achieve lower oxygen transmittance and further superior adhesion even after heat sterilization treatment.

From the comparison between example 1 and example 8, it is found that increasing the amount of the silane coupling agent while making the amount of water-soluble polymers having hydroxyl groups constant tends to increase the atomic number density and also increase the density. In addition, from the comparison between example 1 and example 8, it is found that decreasing the amount of the silane coupling agent while making the amount of water-soluble polymers having hydroxyl groups constant can achieve lower oxygen transmittance and further superior adhesion even after heat sterilization treatment.

From the comparison between example 2 and comparative example 2, it is found that increasing the amount of water-soluble polymers having hydroxyl groups while making the amount of metal alkoxide constant tends to increase the atomic number density and decrease the density. In addition, from the comparison between example 2 and comparative example 2, it is found that increasing the amount of water-soluble polymers having hydroxyl groups while making the amount of metal alkoxide constant can achieve lower oxygen transmittance even after heat sterilization treatment.

### REFERENCE SIGNS LIST

1 . . . substrate layer, 2 . . . anchor coating layer, 3 . . . deposition layer, 4 . . . gas barrier coating layer, 10 . . . gas barrier film

What is claimed is:

1. A gas barrier film, comprising:
a substrate layer including a thermoplastic resin, a deposition layer, and a gas barrier coating layer in this order, wherein
the gas barrier coating layer has an atomic number density of 10.5*10²² to 13.0*10²² atoms/cm³ and a density of 1.6 to 2.1 g/cm³.

2. The gas barrier film of claim 1, wherein
oxygen transmittance after heat sterilization treatment is 5.0 cm³/(m²·day·atm) or lower, and lamination strength after the heat sterilization treatment is 1.5 N/15 mm or greater.

3. The gas barrier film of claim 1, wherein
the thermoplastic resin is a polypropylene resin.

4. The gas barrier film of claim 1, wherein
a content of a polypropylene resin in the gas barrier film is 90 mass % or greater.

5. The gas barrier film of claim 1, further comprising an anchor coating layer between the substrate layer and the deposition layer.

6. The gas barrier film of claim 1, wherein
the deposition layer includes at least one selected from the group consisting of aluminum oxide and silicon oxide.

7. The gas barrier film of claim 1, wherein
the gas barrier coating layer is formed of a cured body of a composition including a water-soluble polymer having a hydroxyl group, a metal alkoxide or hydrolysate thereof, and a silane coupling agent or hydrolysate thereof.

8. The gas barrier film of claim 1, wherein
a content of silicon oxide in the gas barrier coating layer is 30 to 80 mass %.

9. The gas barrier film of claim 1, wherein
a thickness of the gas barrier coating layer is 80 to 1000 nm.

10. A packaging film comprising the gas barrier film of claim 1 and a sealant layer.

11. A packaging bag comprising the packaging film of claim 10.

12. A packaging product comprising the packaging bag of claim 11 and contents accommodated in the packaging bag.
